(19) United States
(12) Patent Application Publication
(10) Pub. No.: US 2021/0199503 A1
(43) Pub. Date: Jul. 1, 2021

(54) DATA PROCESSING SYSTEM DISPOSED ON SENSOR AND METHOD THEREOF

(71) Applicant: INDUSTRIAL TECHNOLOGY RESEARCH INSTITUTE, Hsinchu (TW)

(72) Inventors: Chih-Cheng LU, Hsinchu City (TW); Kai-Cheung JUANG, Hsinchu City (TW)

(73) Assignee: INDUSTRIAL TECHNOLOGY RESEARCH INSTITUTE, Hsinchu (TW)

(21) Appl. No.: 16/727,382

(22) Filed: Dec. 26, 2019

(51) Int. Cl. G01J 3/28; G06N 20/00

(52) U.S. Cl. CPC G01J 3/28; G06N 20/00

(57) ABSTRACT

A data processing system disposed on a sensor comprises a de-identified sensing device and a decoding device. The de-identified sensing device is configured to receive a sensing data of a target and to process the sensing data to generate a de-identified data. The decoding device communicably connects to the de-identified sensing device and is configured to generate a decoded data according to the de-identified data and a decoding parameter obtained from a database trained by machine learning. The de-identified sensing device comprises an analog encoder configured to encode the sensing data to generate a responsive data.

### TECHNICAL FIELD

The present disclosure relates to compressive sensing, and more particularly to a data processing system disposed on a sensor and method thereof.

### BACKGROUND

Because of the sensing requirement of high resolution signal, the filter-based spectrometer needs a large number of filters to capture a large set of target wavelengths, and the non-ideal filtering mechanism makes reconstruction necessary, which leads to increasing hardware costs and high volume of sensors, as well as raised difficulty in the implementation of miniature sensors.

On the other hand, regarding the structure of developing sensing chips, the increasing amount of processing data causes high power consumption in data processing and high throughput of data transmission. Although transferring all of the sensing data to the cloud server for further processing can be an easy way, the burden of the cloud server must be thus largely increased.

### SUMMARY

According to an embodiment of the present disclosure, a data processing system disposed on a sensor comprising: a de-identified sensing device configured to receive a sensing data of a target and to process the sensing data to generate a de-identified data; and a decoding device communicably connecting to the de-identified sensing device and configured to generate a decoded data according to the de-identified data and a decoding parameter obtained from a database trained by machine learning; wherein the de-identified sensing device comprises an analog encoder configured to encode the sensing data to generate a responsive data.

According to an embodiment of the present disclosure, a data processing method performing on a sensor adapted to a data processing system disposed on the sensor, wherein the data processing system comprises a de-identified sensing device and a decoding device, and the method comprises: receiving a sensing data of a target and processing the sensing data to generate a de-identified data by the de-identified sensing device; and generating a decoded data according to the de-identified data and a decoding parameter obtained from a database trained by machine learning; wherein the de-identified sensing device comprises an analog encoder configured to encode the sensing data to generate a responsive data.

According to an embodiment of the present disclosure, a de-identified sensing device configured to receive a sensing data of a target and to process the sensing data to generate a de-identified data comprises an analog encoder configured to encode the sensing data to generate a responsive data; wherein the de-identified data is transferred to a decoding device for generating a decoded data according to the de-identified data and a decoding parameter obtained from a database trained by machine learning.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a block diagram of the data processing system according to an embodiment of the present disclosure;

FIG. 2 is a schematic and exploded view of a de-identified sensing device of the data processing system disposed on a sensor according to the embodiment of the present disclosure;

FIG. 3A is a flowchart of the data processing method performing on a sensor according to an embodiment of the present disclosure;

FIG. 3B is a detailed flowchart of step S1 of FIG. 3A;

FIG. 4A is a detailed flowchart of the data processing method performing on a sensor according to an embodiment of the present disclosure;

FIG. 4B is a detailed flowchart of step A5 of FIG. 4A;

FIG. 4C is a detailed flowchart of step A7 of FIG. 4A; and

FIG. 5 is a flowchart for generating the database.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The data processing system disposed on a sensor proposed in the present disclosure uses a small number of filters to capture information in multiple wavelengths at the same time. Based on the sparse signal recovery principle in compressive sensing as well as the fact that spectrum signals tend to be a smooth curve with some spikes, the present disclosure proposes a signal reconstruction method with high quality.

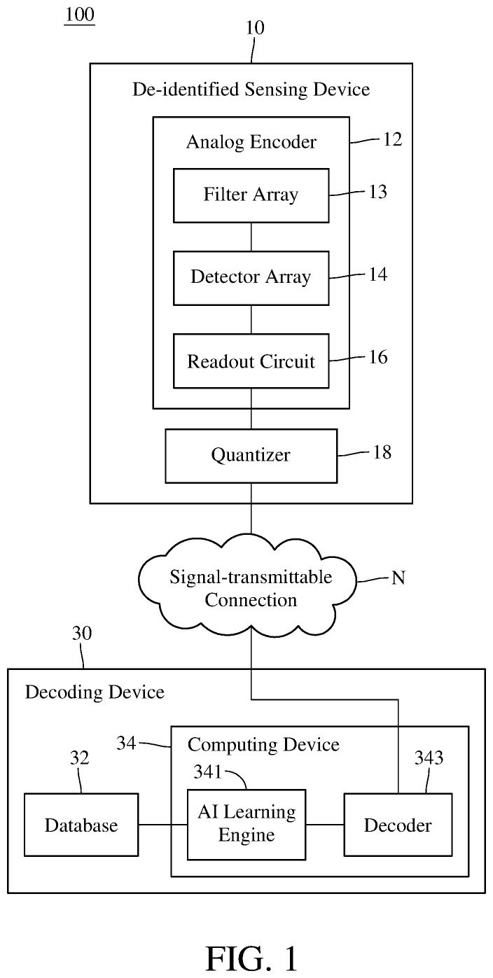

Please refer to FIG. 1, which illustrates a block diagram of the data processing system disposed on a sensor according to an embodiment of the present disclosure. As shown in FIG. 1, the data processing system 100 includes a de-identified sensing device 10 and a decoding device 30.

The de-identified sensing device 10 communicably connects to the decoding device 30. The de-identified sensing device 10 includes an analog encoder 12 and a quantizer 18.

The de-identified sensing device 10 is configured to receive a sensing data of a target and to process the sensing data to generate a de-identified data. In an example, the sensing data is a spectrum data or a spatial data. In an embodiment, the de-identified sensing device 10 includes an analog encoder 12. The analog encoder 12 is configured to encode the sensing data to generate a responsive data.

The decoding device 30 communicably connects to the de-identified sensing device 10 through a signal-transmittable connection N, such as a wire, a local network or the internet. In an example, the decoding device 30 is disposed remotely from the de-identified sensing device 10, with the internet or local network serves as the signal-transmittable connection N. In another example, the signal-transmittable connection N is a signal wire so that the data processing system 100 is implemented as a single device. The decoding device 30 is configured to generate a decoded data according to the de-identified data and a decoding parameter, and the decoding parameter is obtained from a database trained by machine learning.

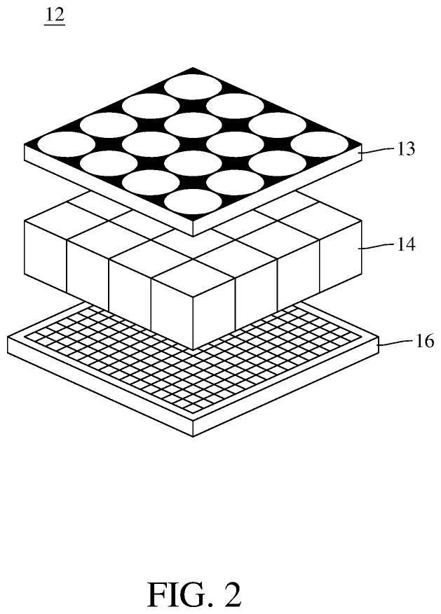

Please refer to FIG. 2, which illustrates a schematic view of the de-identified sensing device 10 according to an example of the present disclosure. In an example, the analog encoder 12 comprises a filter array 13, a detector array 14, and a readout circuit 16. Regarding the relationship of the above three elements in position, the detector array 14 is disposed on the readout circuit 16 and the filter array 13 is disposed on the detector array 14. In other words, the detector array 14 is disposed between the filter array 13 and the readout circuit 16 as shown in FIG. 2.

Please refer to FIG. 2, the filter array 13 includes a plurality of filters. In an example, the filter array 13 is configured to perform a random optical response to the sensing data of the target. The filter array 13 is configured to perform a physical encoding or an electrical signal encoding. The physical parameter of the filter array 13 may be defined as a sensor information.

Specifically, each filter of the filter array 13 may perform a physical encoding operation based on a physical property of the target. For example, the physical encoding operation is based on the wavelength range of the incident light or the spatial arrangement of the target. However, the present disclosure is not limited thereto.

Regarding the implementation of the physical encoding operation based on the wavelength range, for example, each filter of the filter array 13 is coated with a specific material changing the filter's transmittance so that only an incident light within a certain wavelength range can pass through the filter, that is, the filter is a wavelength-selective filter. Thereby, the plurality of filters with different bypass wavelength ranges can generate various information in wavelength about the incident light.

Regarding the implementation of the physical operation based on the spatial arrangement, for example, each filter of the filter array 13 may be installed with an additional encoder, such as optical component capable of diffraction or interference, so that the filter can receive incident lights from multiple points of the sensed target. Coatings and additional encoders described in the above examples are preferred to be disposed randomly on the plurality of the filters of the filter array 13 so as to obtain said various information of the physical property of the incident light.

Please refer to FIG. 2. The detector array 14 includes a plurality of detectors in correspondence with the plurality of filters of the filter array 13. In an example, the wavelength sensing ranges, or the frequency sensing ranges in spectrum, of the plurality of detectors are identical, such as the wavelength range of the visible light, 400-700 nanometers. In another example, at least two detectors of the detector array 14 have different but overlapped wavelength sensing ranges or the frequency sensing ranges.

Please refer to FIG. 2. The readout circuit 16 is configured to generate an analog data according to the sensing data. For example, the analog data may include a spectrum data or a spatial data but not limited thereto. In an example, the readout circuit 16 may perform an electrical encoding for the sensing data in order to decrease the data amount of the analog data.

The quantizer 18 is an Analog-to-Digital Convertor (ADC) configured to convert the responsive data to the de-identified data.

Please refer to FIG. 1. The decoding device 30 includes a database 32 and a computing device 34. In an example, the decoding device 30 is a cloud server. The database 32 is configured to store a plurality of decoding parameters generated by machine learning via a collection of training data, wherein the dimension of the training data is greater than the dimension of the analog data. The computing device 34 is configured to obtain one of the plurality of decoding parameters from the database 32 according to the de-identified data and convert the de-identified data into a decoded data according to said one of the plurality of the decoding parameters, wherein the dimension of the decoded data is greater than the dimension of the analog data. In an embodiment, the computing device 34 includes an Artificial Intelligence (AI) Learning Engine 341 and a decoder 343.

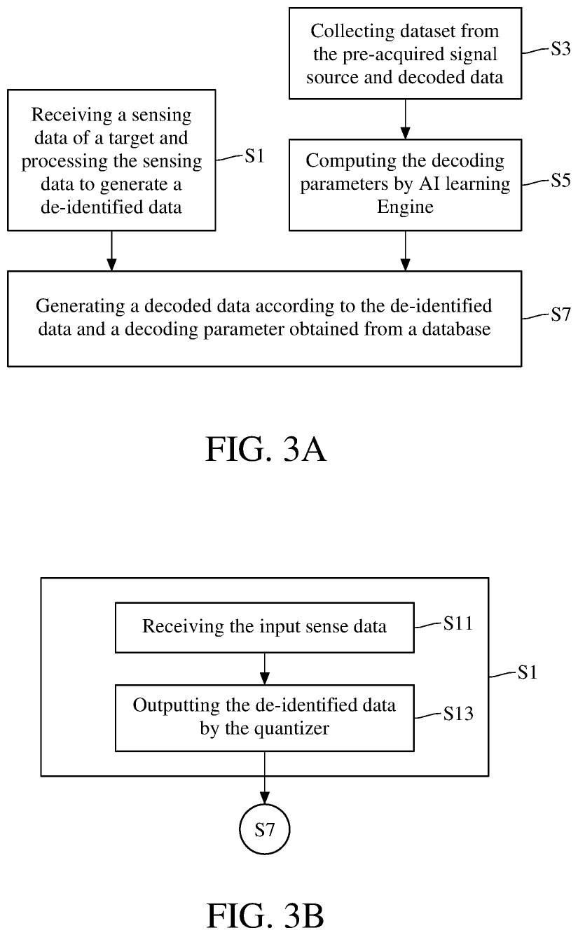

Please refer to FIG. 3A, which illustrates a flowchart of the data processing method performing on a sensor according to an embodiment of the present disclosure.

Please refer to step S1, which shows receiving a sensing data of a target and processing the sensing data to generate a de-identified data. Please refer to FIG. 3B, which illustrates a detailed flowchart of step S1 of FIG. 3A. Please refer to step S11, which shows receiving the input sense data. In this step, the de-identified sensing device 10 receives the input sense data through the analog decoder 12. The analog decoder 12 includes a physical encoded component or an electrical encoded component. The input sense data is combined by the analog encoded component and the sensor information. Please refer to step S13, which shows outputting the de-identified data by the quantizer.

Please refer to step S3, which shows collecting dataset from the pre-acquired signal source and decoded data.

Please refer to step S5, which shows computing the decoding parameters by AI learning Engine 341.

Please refer to step S7, which shows generating a decoded data according to the de-identified data and a decoding parameter obtained from a database.

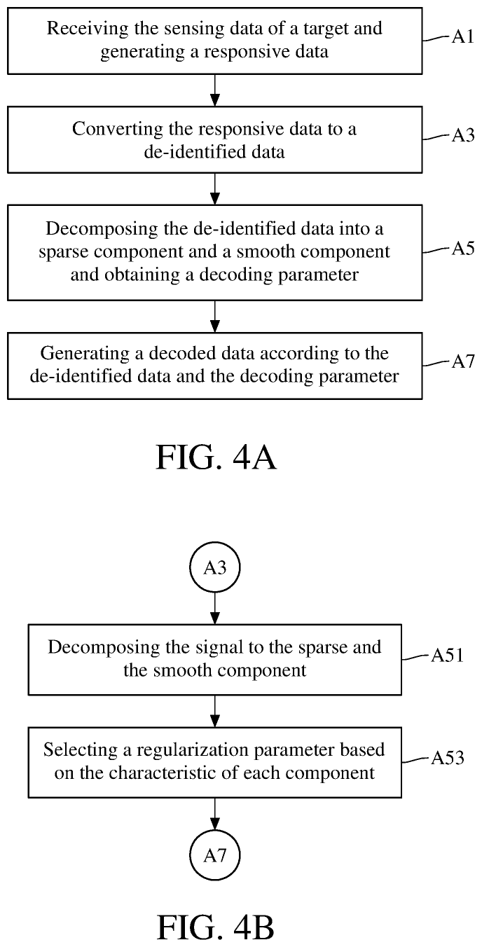

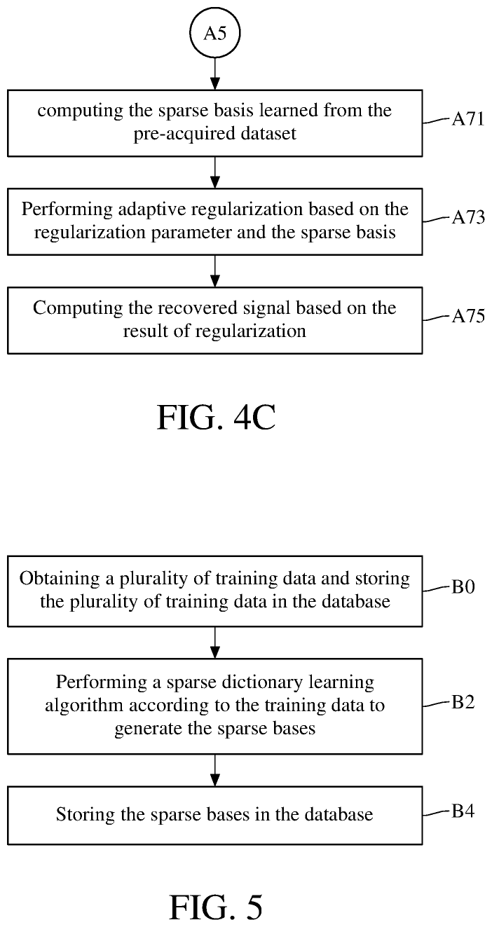

The details of steps S1, S3, S5 and S7 are illustrated in FIG. 4A and FIG. 5.

Please refer to FIG. 4A, which illustrates a detailed flowchart of the data processing method performing on a sensor according to an embodiment of the present disclosure. Specifically, in FIG. 4, step A1 and A3 show an example corresponding to step S1 of FIG. 3A, and steps A5 and A7 show an example corresponding to step S7 of FIG. 3A.

Please refer to step A1, which shows receiving the sensing data of a target and generating a responsive data. In an example, the filter array 13 includes a plurality of filters coated randomly, and performs a physical encoding or an electrical signal encoding to the sensing data. Combined with sensor information, the detector array 14 and the readout circuit 16 generate a responsive data. In an example, the responsive data is a random optical response data, wherein each detector of the detector array 14 may obtain the incident light with multiple wavelengths.

Please refer to step A3, which shows converting the responsive data to the de-identified data. In an example, an ADC is used to serve as the quantizer 18 to convert the responsive data into the de-identified data.

Please refer to step A5, which shows decomposing the de-identified data into a sparse component and a smooth component and obtaining the decoding parameters. Please refer to FIG. 4B, which shows a detailed flowchart of step A5 of FIG. 4. Please refer to step A51, which shows decomposing the signal to the sparse and the smooth component. The signal is such as the de-identified data. Specifically, because real signals are either entirely sparse or smooth, the present disclosure adopts step A5 to recover complex signals such as real plastic materials. According to the compressive sensing theory, sparse nature of signal can be captured and represented at a rate significantly below the Nyquist rate. For the de-identified data, the decoder 343 of the computing device 34 of the decoding device 30 decomposes the de-identified data into a sparse component and a smooth component. Please refer to step A53, which shows selecting a regularization parameter based on the characteristic of each component. Specifically, the decoder 343 of the computing device 34 of the decoding device 30 further selects regularization parameters to serve as the decoding parameters according to the characteristic of each component. In an example, the decoding parameters include a regularization parameter corresponding to the sparse component and a regularization parameter corresponding to the smooth component.

Please refer to step A7, which shows generating a decoded data according to the de-identified data and a decoding parameter. Please refer to FIG. 4C, which shows a detailed flowchart of step A7 of FIG. 4A. Please refer to step A71, which shows computing the sparse basis learned from the pre-acquired dataset. In step A71, the computing device 34 computes the sparse basis according to the de-identified data and the sparse induced database stored in database 32. Specifically, the decoder 343 of the computing device 34 determines a sparse basis according to the characteristic of the sparse component, wherein the sparse basis is stored in the database 32. The database 32 collects a sparse induced database from the pre-acquired signals and decoded signals and uses the AI Learning Engine 341 of the computing device 34 to perform a machine learning algorithm to generate plurality of sparse basis. In an example, the computing device 34 further obtains the decoding parameter according to the sparse basis and the regularization parameter.

Please refer to step A73, which shows performing adaptive regularization based on the regularization parameter and the sparse basis. In an example, the decoder 343 of the computing device 34 may adopt an adaptive regularization or a proximal gradient descent method to solve the following optimization problem in order to convert the de-identified data into the decoded data.

$${arg min}_{v , z} {‖ y - φ ( v + ψ z ) ‖}_{2}^{2} + {λ}_{1} {‖ z ‖}_{1} + {λ}_{2} {‖ Av ‖}_{2}^{2}$$

wherein, y is the de-identified data measured by the de-identified sensing device 10, ϕ is the filter characteristics matrix (i.e., the sensing matrix) which is measured in advance, ν is the smooth component, ψ is the sparse basis, z is the sparse component, λ₁ is the regularization parameter corresponding to the sparse component, λ₂ is the regularization parameter corresponding to the smooth component, and A is a bidiagonal (1, −1) matrix such that Aν captures gradients in adjacent components of ν. The sparse basis ψ and the regularization parameters λ₁ and λ₂ are served as decoding parameters in this example. Based on the sparse basis and the decoding parameters obtained in step A5, the decoder 343 of the computing device 34 performs adaptive regularization to find an appropriate ν and z, and generates the decoded data, wherein the dimension of the decoded data is greater than the dimension of the analog data.

Please refer to A75, which shows computing the recovered signal based on the result of regularization. Therefore, with the dimension of the training data larger than that of the analog data and meeting a required resolution, the resolution corresponding to the dimension of the decoded data can satisfy the requirement although the dimension of the analog data may be much smaller than a dimension in correspondence with the required resolution. In addition, the number of the detectors in the detector array 14 can be decreased.

The way to generate the decoding parameters mentioned above is further discussed as the following. Please refer to FIG. 5, which illustrates a flowchart for generating the database. Specifically, in FIG. 5, step BO shows an example corresponding to the step S3 of FIG. 3A, steps B2 and B4 show an example corresponding to step S5 of FIG. 3A.

Please refer to step BO, which shows obtaining a plurality of training data and storing the plurality of training data in the database 32. Specifically, the present disclosure may adopt another spectrometer to collect spectrum signals with high resolution, wherein said another spectrometer includes another detector array and the number of detectors of said another detector array is greater than that the number of the detectors of the detector array 14. For example, the present disclosure adopts a RED-Wave-NIRX-SR spectrometer with SL1 tungsten lamp to acquire the reflection spectra off plastics from 1000 nanometers to 1656 nanometers at a very high resolution (1 nanometer). The present disclosure adopts seven different types of plastics according to American Society for Testing and Materials (ASTM) international standards to measure several spectrums from different items within the same plastic type for capturing the inter and intra-class variations of different plastic types, or to measure several spectrums of the same item with varying distance, location, and angle for capturing the variations in measuring the same material.

Please refer to step B2, which shows performing a sparse dictionary learning algorithm to generate a plurality of sparse basis according to training data. This step may be implemented by performing the machine learning algorithm, or performing the neural network model with the AI Learning Engine 341 of the computing device 34.

Please refer to step B4, which shows storing the sparse basis in the database. The AI Learning Engine 341 of the computing device 34 stores the sparse basis generated in step B2 in the database 32 for future use.

In view of the above, the data processing system disposed on a sensor and the data processing method performing on the sensor proposed in the present disclosure may decrease the number of optical components (including detectors of the detector array) and generate high resolution signal with sensing data from a small number of sensors. Therefore, the sensor may be further miniaturized. Furthermore, the signal reconstruction method based on machine learning may help to decrease the cost of the sensor and satisfy the private requirement of the de-identification of the sensor.

What is claimed is:

1. A data processing system disposed on a sensor comprising:
a de-identified sensing device, configured to receive a sensing data of a target and to process the sensing data to generate a de-identified data; and
a decoding device, communicably connecting to the de-identified sensing device and configured to generate a decoded data according to the de-identified data and a decoding parameter obtained from a database trained by machine learning;
wherein the de-identified sensing device comprises an analog encoder configured to encode the sensing data to generate a responsive data.

2. The data processing system disposed on the sensor of claim 1, wherein the sensing data is a spectrum data or a spatial data.

3. The data processing system disposed on the sensor of claim 1, wherein the analog encoder comprises a filter array, a detector array and a readout circuit; and wherein the filter array is configured to perform a physical encoding or an electrical signal encoding, the detector array is disposed on the readout circuit, and the filter array is disposed on the detector array.

4. The data processing system disposed on the sensor of claim 3, wherein the filter array is configured to perform a random optical response to the sensing data of the target.

5. The data processing system disposed on the sensor of claim 3, wherein the detector array comprises a plurality of detectors whose frequency sensing ranges or wavelength sensing ranges are identical to one another.

6. The data processing system disposed on the sensor of claim 1, wherein the de-identified sensing device further comprises a quantizer implemented by an Analog-to-Digital Convertor configured to convert the responsive data to the de-identified data.

7. A data processing method performing on a sensor adapted to a data processing system disposed on the sensor, wherein the data processing system comprises a de-identified sensing device and a decoding device, and the method comprises:
receiving a sensing data of a target and processing the sensing data to generate a de-identified data by the de-identified sensing device; and
generating a decoded data according to the de-identified data and a decoding parameter obtained from a database trained by machine learning;
wherein the de-identified sensing device comprises an analog encoder configured to encode the sensing data to generate a responsive data.

8. The data processing method performing on the sensor of claim 7, wherein the analog encoder comprises a filter array, a detector array and a readout circuit; and receiving the sensing data of the target and processing the sensing data to generate the de-identified data by the de-identified sensing device comprises:
performing a physical encoding or an electrical signal encoding to the sensing data by the filter array.

9. The data processing method performing on the sensor of claim 7, wherein generating the decoded data according to the de-identified data and the decoding parameter obtained from the database trained by machine learning comprises:
decomposing the de-identified data into a sparse component and a smooth component by the decoding device; and
selecting a regularization parameter respectively according to the sparse component and the smooth component.

10. The data processing method performing on the sensor of claim 9, wherein generating the decoded data according to the de-identified data and the decoding parameter obtained from the database trained by machine learning further comprises:
computing a sparse basis according to the database by the decoding device with a sparse induced database, wherein the decoding device computing the sparse basis according to the de-identified data and the sparse induced database.

11. The data processing method performing on the sensor of claim 10, wherein generating the decoded data according to the de-identified data and the decoding parameter obtained from the database trained by machine learning further comprises:
obtaining the decoding parameter according to the sparse basis and the regularization parameter; and
performing an adaptive regularization to generate the decoded data.

12. The data processing method performing on the sensor of claim 8, wherein the de-identified sensing device further comprises a quantizer implemented by an Analog-to-Digital Convertor, and receiving the sensing data of the target and processing the sensing data to generate the de-identified data by the de-identified sensing device further comprises:
converting the responsive data to the de-identified data by the Analog-to-Digital Convertor.

13. A de-identified sensing device configured to receive a sensing data of a target and to process the sensing data to generate a de-identified data comprising:
an analog encoder, configured to encode the sensing data to generate a responsive data;
wherein the de-identified data is transferred to a decoding device for generating a decoded data according to the de-identified data and a decoding parameter obtained from a database trained by machine learning.

14. The de-identified sensing device of claim 13, wherein the sensing data is a spectrum data or a spatial data.

15. The de-identified sensing device of claim 13, wherein the analog encoder comprises a filter array, a detector array and a readout circuit; wherein the filter array is configured to perform a physical encoding or an electrical signal encoding, the detector array is disposed on the readout circuit and the filter array is disposed on the detector array.

16. The de-identified sensing device of claim 15, wherein the filter array is configured to perform a random optical response to the sensing data of the target.

17. The de-identified sensing device of claim 15, wherein the detector array comprises a plurality of detectors whose frequency sensing range or wavelength sensing range are identical to one another.

18. The de-identified sensing device of claim 15, further comprising a quantizer, wherein the quantizer is an Analog-to-Digital Convertor configured to convert the responsive data to the de-identified data.
